(19) United States
(12) Patent Application Publication
(10) Pub. No.: US 2025/0039318 A1
(43) Pub. Date: Jan. 30, 2025

(54) IMAGE PROCESSING SYSTEM, IMAGE PROCESSING METHOD, AND NON-TRANSITORY COMPUTER READABLE MEDIUM

(71) Applicant: FUJIFILM Business Innovation Corp., Tokyo (JP)

(72) Inventor: Tetsuo SUZUKI, Kanagawa (JP)

(73) Assignee: FUJIFILM Business Innovation Corp., Tokyo (JP)

(21) Appl. No.: 18/442,051

(22) Filed: Feb. 14, 2024

(30) Foreign Application Priority Data
Jul. 24, 2023 (JP) 2023-119604

(51) Int. Cl. H04N 1/21; H04N 1/00

(52) U.S. Cl. CPC H04N 1/21; H04N 1/00482; H04N 2201/0094

(57) ABSTRACT

An image processing system includes: a camera; and a processor configured to: analyze a captured image of a document on a document glass, the captured image being captured with the camera, and extract storage-location information from the document; and save a read image of the document onto a storage location specified by the storage-location information, the read image being acquired through image capturing by the camera in response to a reading instruction from a user.

### CROSS-REFERENCE TO RELATED APPLICATIONS

This application is based on and claims priority under 35 USC 119 from Japanese Patent Application No. 2023-119604 filed Jul. 24, 2023.

### BACKGROUND

### (i) Technical Field

The present disclosure relates to an image processing system, an image processing method, and a non-transitory computer readable medium.

### (ii) Related Art

In recent years, it has become possible to capture an image of a document, for example, by using a camera included in a mobile terminal instead of using what is usually called a scanner, which is a device for reading a document. For example, an image captured with a camera included in a mobile terminal is transmitted to a printer to enable the printer to print the captured image.

Similarly, a multifunction peripheral equipped with a camera, such as a document camera, is also being developed, and the use of a captured image as a read image is being studied. When using a multifunction peripheral equipped with a document camera, a user places a document face up on a document glass. The document camera reads the document on the document glass by capturing an image of the document from above. In contrast to the use of an existing multifunction peripheral, the document camera renders lifting and lowering the cover for the document glass unnecessary when the document is placed on the document glass. A document camera is also convenient when a page of a bound document such as a book is read.

One of the functions provided by a multifunction peripheral to a user is transmitting a read image of a document via a network and saving the read image onto a predetermined storage location. In such a case, the user used to be prompted to specify the storage location for the read image of the document. Japanese Unexamined Patent Application Publication No. 2019-176422 is an example of related art.

### SUMMARY

Specifying a storage location for a read image of a document every time is inconvenient for a user. Setting candidates for the storage location in advance and prompting the user to select one from the candidates may dispense with entering the storage location every time. However, even in such a case, the user needs to perform operation of displaying on a screen a list of candidates for the storage location and selecting the storage location from the list. Operation of registering storage locations in advance is also necessary.

Aspects of non-limiting embodiments of the present disclosure relate to enabling the user to save a read image without specifying the storage location.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image processing system including: a camera; and a processor configured to: analyze a captured image of a document on a document glass, the captured image being captured with the camera, and extract storage-location information from the document; and save a read image of the document onto a storage location specified by the storage-location information, the read image being acquired through image capturing by the camera in response to a reading instruction from a user.

### BRIEF DESCRIPTION OF THE DRAWINGS

An exemplary embodiment of the present disclosure will be described in detail based on the following figures, wherein:

FIG. 1 depicts an example of an overall configuration of an image processing system and a block diagram of a multifunction peripheral according to the exemplary embodiment of the present disclosure;

FIG. 2 is a schematic perspective view of the multifunction peripheral according to the present exemplary embodiment;

FIG. 3 depicts a hardware configuration of the multifunction peripheral according to the present exemplary embodiment;

FIG. 4 is a flowchart depicting a scanning process according to the present exemplary embodiment;

FIG. 5 depicts an example of a basic settings screen according to the present exemplary embodiment;

FIG. 6 depicts an example of a detailed settings screen according to the present exemplary embodiment; and

FIG. 7 depicts an example of a display screen for folders as a storage location onto which a read image of a document is saved according to the present exemplary embodiment.

### DETAILED DESCRIPTION

Hereinafter, an exemplary embodiment of the present disclosure will be described with reference to the drawings.

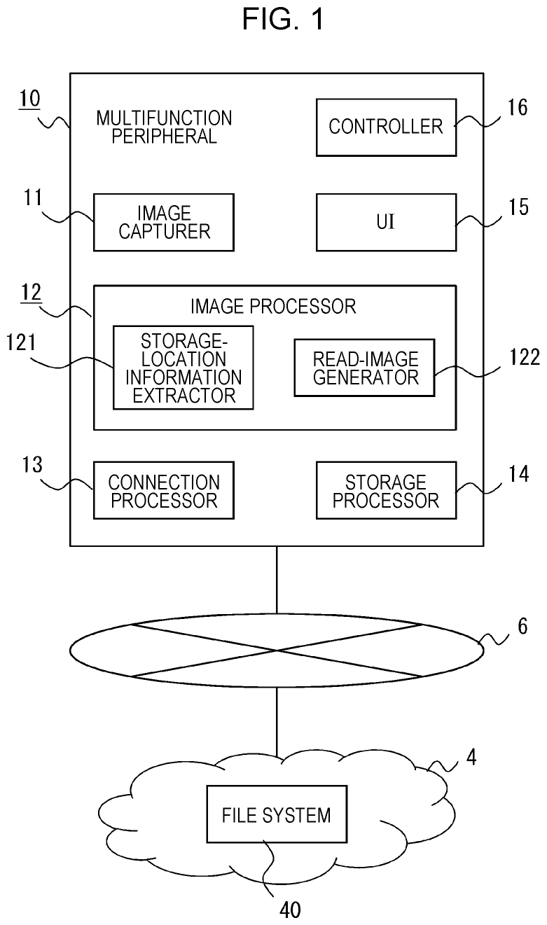

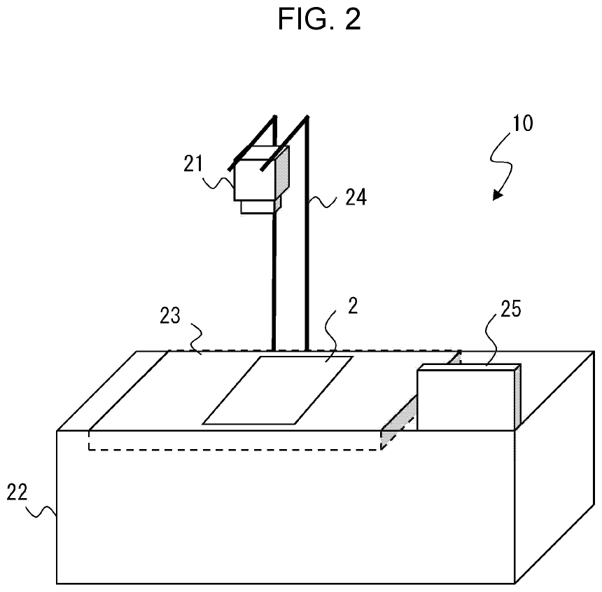

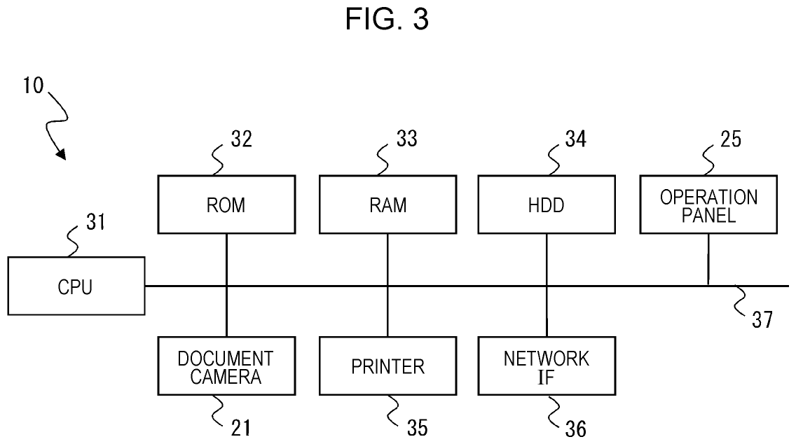

FIG. 1 depicts an example of an overall configuration of an image processing system and a block diagram of a multifunction peripheral 10 according to the exemplary embodiment of the present disclosure. FIG. 2 is a schematic perspective view of the multifunction peripheral 10 according to the present exemplary embodiment, and FIG. 3 depicts a hardware configuration of the multifunction peripheral 10 according to the present exemplary embodiment.

A characteristic feature of the device configuration of the multifunction peripheral 10 according to the present exemplary embodiment is that the multifunction peripheral 10 is equipped with a document camera 21 as depicted in FIG. 2. The multifunction peripheral 10 is equipped with a document glass 23 disposed on the top surface of an apparatus body 22 and is equipped with the document camera 21 capable of capturing an image of the entire area of the document glass 23. The document camera 21 is supported with supporting rods 24. Further, an operation panel 25 is disposed on the top surface of the apparatus body 22 and serves as an input unit operated by a user and also as a display for displaying information.

The multifunction peripheral 10 according to the present exemplary embodiment is an example of an image forming apparatus having various functions such as a printing function, a copying function, and a scanning function and includes a computer. Specifically, as depicted in FIG. 3, the multifunction peripheral 10 includes a central processing unit (CPU) 31, a read-only memory (ROM) 32, a random-access memory (RAM) 33, a hard disk drive (HDD) 34 as a storage, the operation panel 25 as a user interface, the document camera 21 as a camera, a printer 35 configured to provide the printing function, and a network interface (IF) 36 as a communicator. An address data bus 37 connects the CPU 31 and the various components 32 to 36, 21, and 25, which are controlled by the CPU 31, and data communication is performed.

Existing multifunction peripherals usually include a scanner configured to optically read a document 2 on the document glass 23 to implement the scanning function. The multifunction peripheral 10 according to the present exemplary embodiment includes the document camera 21 instead of a scanner. Thus, a read image of the document 2 is generated from a captured image acquired through image capturing by the document camera 21 or from an analysis of the captured image. Since the document camera 21 is configured to generate a captured image of the document 2 by capturing an image of the document 2 on the document glass 23, the document camera 21 may also be said to read the document 2 by image capturing, and the terms “image capturing” and “reading” are not strictly distinguished and are used interchangeably in the present exemplary embodiment. Thus, the term “image capturing” by the document camera 21 is replaced with “reading” in some cases, and “image capturing” by the document camera 21 is also referred to as “reading” or “scanning”.

As depicted in FIG. 1, the image processing system according to the present exemplary embodiment has a configuration in which the multifunction peripheral 10 and a cloud 4 are connected to each other by using a network 6 including the Internet. Each multifunction peripheral 10 having the functions provided in the present exemplary embodiment invariably includes the functional blocks depicted in FIG. 1, and only one apparatus is depicted in FIG. 1 for the sake of convenience. The cloud 4 includes a file system used for saving and managing a file, which is a read image of the document 2, transmitted from the multifunction peripheral 10.

As depicted in FIG. 1, the multifunction peripheral 10 includes an image capturer 11, an image processor 12, a connection processor 13, a storage processor 14, a user interface (UI) 15, and a controller 16. In FIG. 1, components that are not used for description of the present exemplary embodiment are omitted.

The image capturer 11 is implemented with the document camera 21 and is configured to capture an image of at least the entire top surface of the document glass 23. The image processor 12 is configured to perform image processing on the captured image acquired with the document camera 21, as a processing target. The image processor 12 includes a storage-location information extractor 121 and a read-image generator 122. In the present exemplary embodiment, a data code containing storage-location information, such as a QR code (registered trademark), is set to specify the storage location for a read image of the document 2 and is attached to the document 2, for example, by printing, details of which will be described below. Instead of printing a QR code, for example, a sticker label having a QR code may be attached to the document 2. The storage-location information extractor 121 is configured to, if a QR code is detected by an analysis of a captured image of the document 2, extract the storage-location information from the QR code. The read-image generator 122 is configured to generate a read image of the document 2 from a captured image in accordance with reading attributes set for the document 2.

The connection processor 13 is configured to, in response to a reading instruction from the user, connect to a connection destination specified in the storage-location information. In the present exemplary embodiment, description will be given on the assumption that the storage location specified in the storage-location information is a file system 40, and thus the multifunction peripheral 10 needs to connect to the file system 40 via a network in advance to save a read image (also referred to as a “file” below) of the document 2 onto the file system 40. Since the file is saved after the connection to the file system 40 is established in the present exemplary embodiment, “connection destination” and “storage location” coincide and are used interchangeably for convenience of description. Strictly speaking, the connection destination is the file system 40, and the storage location is a folder in the file system 40, which is the connection destination. The folder is specified using, for example, a uniform resource locator (URL).

The storage processor 14 is configured to save the read image of the document 2 onto the storage location specified in the storage-location information. The user interface 15 is implemented with the operation panel 25 and is configured to display various menu screens for the multifunction peripheral 10 and, for example, when a screen is transmitted from the file system 40, display such a screen. The user interface 15 is also configured to accept user's operation on a displayed screen. The controller 16 is configured to control operation of the various components 11 to 15 described above.

Each of the components 11 to 16 of the multifunction peripheral 10 is implemented by cooperation between the computer installed into the multifunction peripheral 10 and programs running on the CPU 31 installed onto the computer.

The programs used in the present exemplary embodiment may be provided not only via a communicator but also in a stored form using a computer-readable recording medium, such as a universal-serial-bus (USB) memory. The programs provided using the communicator or the recording medium are installed onto the computer, and the CPU 31 of the computer executes the programs consecutively to perform various processes.

An apparatus such as the multifunction peripheral 10 and the file system 40 included in the image processing system are each depicted as a single apparatus but may be implemented as a combination of multiple computers or apparatuses.

Next, operation according to the present exemplary embodiment will be described.

In the present exemplary embodiment, as a prerequisite, the document 2, which is to be saved, needs to include storage-location information attached in the form of a data code, such as a QR code, to specify the storage location. In the present exemplary embodiment, description will be given on the assumption that the storage location is specified using a URL.

Although the description will be given with regard to a case where a QR code is used as a method of attaching storage-location information to the document 2 as an example in the present exemplary embodiment, other formats may be used as long as the storage-location information may be extracted by an analysis of a captured image acquired with the document camera 21. For example, if no security issue arises, the storage-location information may be attached in the form of text information, and the storage-location information may be extracted from a captured image using optical character recognition (OCR).

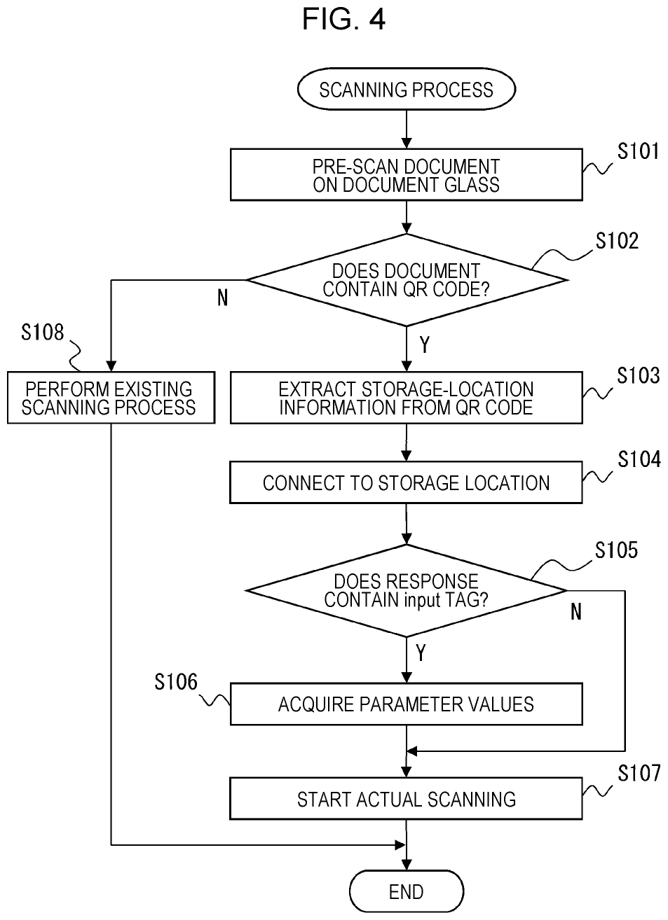

A scanning process for the document 2 using the document camera 21 in the present exemplary embodiment will be described herein with reference to a flowchart depicted in FIG. 4.

When a user is to save the document 2, which is scanned using the scanning function, onto a predetermined storage location, the user selects a scan and transmit button in a home screen (also referred to as a “basic menu screen”) displayed by the operation panel 25 of the multifunction peripheral 10. In response to the scan and transmit button being selected, the document camera 21 starts to capture images at regular intervals. The operation of the document camera 21 may be triggered not only by the selection of the scan and transmit button but also by other actions, such as login by the user to the multifunction peripheral 10.

The user places the document 2 on the document glass 23 before or after selecting the scan and transmit button. At this time, the user places the document 2 face up so that the printed surface to be read to which the QR code is attached may be seen from above.

Once the document 2 is placed on the document glass 23, the image capturer 11 pre-scans the document 2 with the document camera 21 (step S101). Description will be given below with regard to “pre-scan”. The document 2 being placed on the document glass 23 is detected, for example, through a change in the captured images acquired with the document camera 21 at regular intervals.

Subsequently, the storage-location information extractor 121 analyzes the captured images of the document 2 acquired through pre-scanning to try to detect a QR code. If the QR code cannot be detected at this time (N in step S102) or if storage-location information cannot be extracted from the QR code after the QR code is detected, the multifunction peripheral 10 determines that the QR code cannot be detected and performs a scanning process similar to an existing scanning process (step S108). The existing scanning process involves a process of prompting a user to specify the storage location for a read image of the document 2 and does not involve a process of using a scanner as a reading unit to read the document 2.

In contrast, if the QR code is detected (Y in step S102), the storage-location information extractor 121 extracts storage-location information from the QR code (step S103).

Subsequently, the connection processor 13 connects to the connection destination, the file system 40, which may be specified by referring to the storage-location information (step S104).

As is evident from the above process, “pre-scanning” is a scanning process performed on the document 2 to acquire the storage-location information for specifying the storage location for a read image of the document 2, that is, a scanning process performed to acquire the connection destination for the multifunction peripheral 10, and pre-scanning is performed before a scanning process (also referred to as “actual scanning” below) for acquiring a read image of the document 2 to be saved. In the present exemplary embodiment, as described above, pre-scanning is performed through image capturing by the document camera 21. An attribute such as a reading attribute including resolution need not be particularly specified for pre-scanning as long as the storage-location information is extracted from the document 2.

When the multifunction peripheral 10 connects to the file system 40, the content returned in response to the connection process is sometimes a web page described in a hypertext markup language (HTML) containing an input tag. In such a case (Y in step S105), the user interface 15 causes the operation panel 25 to display the screen generated from the web page before the document camera 21 is caused to capture an image of the document 2 again, that is, before actual scanning is performed.

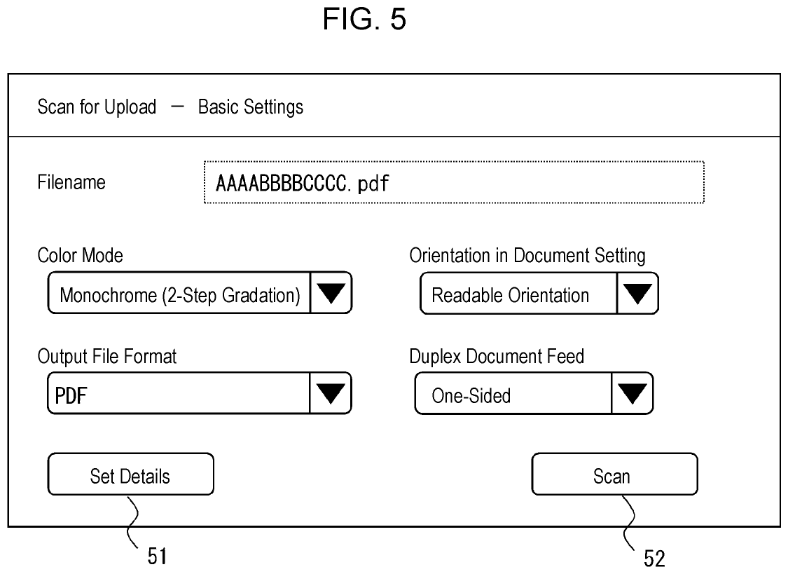

FIG. 5 depicts an example of a basic settings screen created from a web page described in an HTML containing an input tag. The basic settings screen includes input fields for major reading attributes (also referred to as “parameters” below) among reading attributes that may be set when a read image of the document 2 is generated, and such parameters in the basic settings screen include, among others, a parameter to which the user is likely to assign an appropriate parameter value, in other words, a parameter for which the user is unlikely to select a default value. In the basic settings screen depicted in FIG. 5, the user is allowed to set various parameter values such as a filename to be assigned when a read image of the document 2 is saved, the color mode, the orientation setting for the placed document, the output file format, and the duplex document feed. Each parameter is assigned a default value, and the user need not bother to enter a parameter value if the default value need not be changed. The filename may be displayed as a default value by automatically extracting a title from the document 2, referring to, for example, the date and time, or automatically creating a filename in accordance with a predetermined rule for creation. The parameters that may be set in the basic settings screen are presented for illustrative purposes in FIG. 5 and need not be limited to the parameters depicted in FIG. 5. The basic settings screen depicted in FIG. 5 as an example includes a Set Details button 51 and a Scan button 52. If the user determines that parameters other than the parameters presented in the basic settings screen need not be changed, the user selects the Scan button 52 as a reading instruction to read the document 2, that is, an instruction to perform actual scanning. In this way, the image processor 12 acquires parameter values set in the basic settings screen and parameter values set by default for other parameters (step S106). Then, the actual scanning described above starts in accordance with the acquired parameter values (step S107). In contrast, if the user wants to set reading attributes in more detail, the user selects the Set Details button 51.

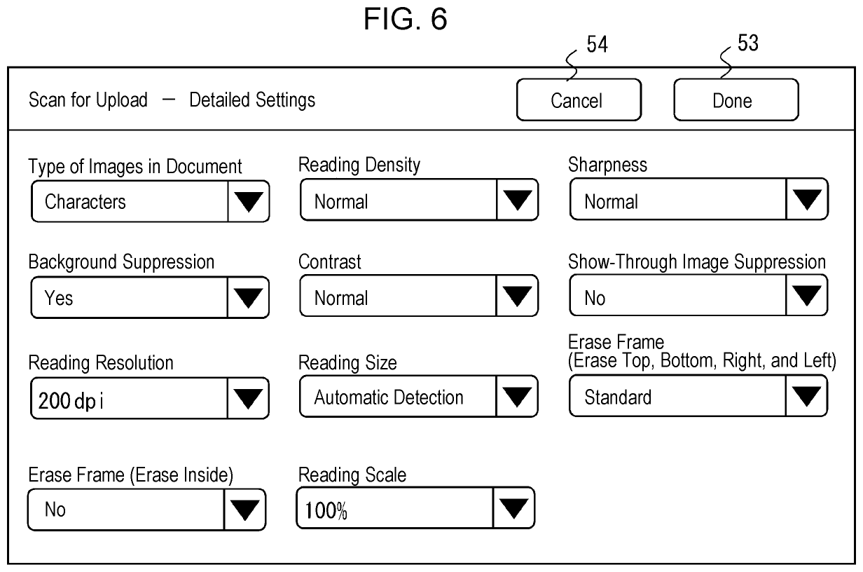

FIG. 6 depicts an example of a detailed settings screen that the user interface 15 causes the operation panel 25 to display in response to the Set Details button 51 being selected. The detailed settings screen may be acquired together with the basic settings screen or may be acquired from the file system 40 in response to the Set Details button 51 being selected. The detailed settings screen includes input fields for reading attributes other than the reading attributes set in the basic settings screen among the reading attributes that may be set when a read image of the document 2 is generated. The reading attributes that may be set in the detailed settings screen are presented for illustrative purposes in FIG. 6 and need not be limited to the reading attributes depicted in FIG. 6.

When the user selects a Done button 53 after setting appropriate parameter values in the detailed settings screen, the user interface 15 resets the screen displayed by the operation panel 25 to the basic settings screen depicted in FIG. 5. If the user wants to cancel the parameter values set in the detailed settings screen and return to the basic settings screen, the user may simply select a Cancel button 54.

When the user selects the Scan button 52 after setting parameter values necessary to generate a read image in the basic settings screen or, if necessary, in the detailed settings screen as described above, the image processor 12 acquires the parameter values (step S106). Then, the image capturer 11 starts actual scanning of the document 2 using the document camera 21 (step S107).

The document camera 21 may capture the same image of the document 2 during pre-scanning and actual scanning. However, while only storage-location information needs to be extracted from a captured image of the document 2 acquired through pre-scanning, a read image of the document 2 needs to be generated, in accordance with the parameter values set in each of the settings screens, from a captured image acquired through actual scanning. Two types of processing are possible to generate a read image of the document 2.

In one type of processing, referring to the reading attributes that are set, the image capturer 11 sets parameters to be used for image capturing and generates a captured image. In this case, the read-image generator 122 does not need to change the read image of the document 2 included in the captured image and may use the read image of the document 2 included in the captured image as the read image of the document 2 to be saved. Naturally, since the document camera 21 captures an image of the entire top surface of the document glass 23, the read-image generator 122 needs to generate the read image of the document 2 by cutting an image of the document 2 out of the captured image.

In the other type of processing, the image capturer 11 constantly captures an image with high precision, that is, in accordance with the maximum or the most suitable parameter values. Then, the read-image generator 122 generates a read image of the document 2 from the captured image in accordance with reading attributes set by the user.

For example, for the resolution, which is one of the reading attributes, the user may set the attribute value (“parameter value” described above) to 200 dpi. In the former case, the document camera 21 captures an image with a resolution of 200 dpi in accordance with the user's setting. In the latter case, the document camera 21 captures an image with the highest resolution, for example, 600 dpi. Then, the read-image generator 122 performs image processing on the captured image with a 600-dpi resolution to generate a read image with a 200-dpi resolution. Since image processing for increasing the resolution (for example, from 100 dpi to 200 dpi) is difficult, a captured image is generated with the maximum parameter value.

In the latter case, if an image of the document 2 is captured with the maximum parameter value during pre-scanning, actual scanning need not be performed separately since the captured image acquired through pre-scanning may be used. A heavier load, meanwhile, needs to be handled to generate a captured image during pre-scanning in the latter case than in the former case.

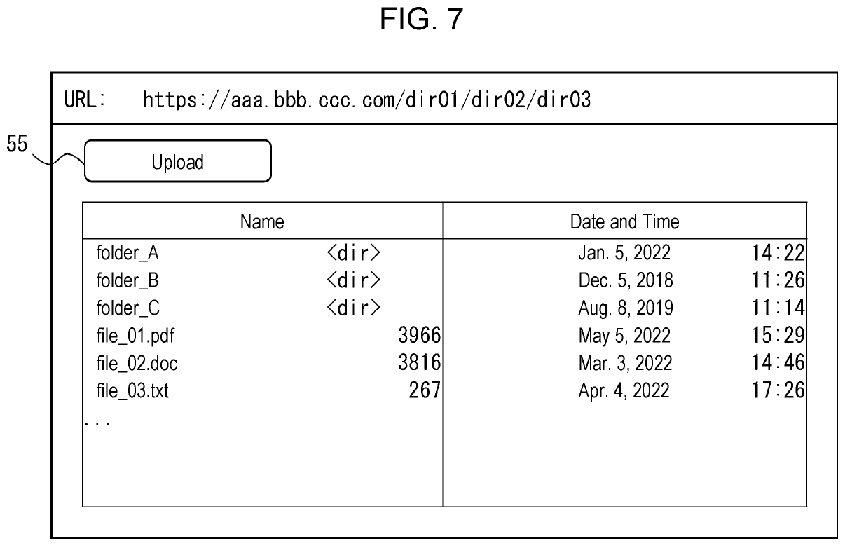

If the content returned in response to the multifunction peripheral 10 connecting to the file system 40 is not a web page described in an HTML containing an input tag (N in step S105), the image capturer 11 automatically starts actual scanning of the document 2 using the document camera 21 (step S107). Subsequently, in accordance with the default values of the reading attributes, the read-image generator 122 generates a read image of the document 2 from a captured image acquired through actual scanning. If the content returned from the file system 40 in response is a web page described in an HTML containing no input tag, a display screen depicted in FIG. 7 as an example is created from the web page described in the HTML.

FIG. 7 depicts an example of a display screen for folders as storage locations onto which a read image of the document 2, that is, a file, is to be saved. In step S104, the connection processor 13 connects to the file system 40 in accordance with the URL as the storage-location information. In response to the connection process, the file system 40 returns a web page as the information indicating folders corresponding to the specified URL. In this way, the user interface 15 causes the operation panel 25 to display the display screen depicted in FIG. 7.

The user may check the storage locations in advance by referring to the folders displayed by the operation panel 25. Subsequently, when the user selects an Upload button 55, the operation panel 25 displays the basic settings screen depicted in FIG. 5.

The storage processor 14 transmits the read image of the document 2 generated as above to the file system 40, which is the storage location, and saves the read image onto the storage location specified by the URL.

As described above, according to the present exemplary embodiment, since a QR code containing the storage-location information is attached to the document 2 and the QR code is pre-scanned with the document camera 21, a read image of the document 2 may be saved without prompting the user to specify the storage location for the read image.

In the present exemplary embodiment, instead of an existing scanner of the optical type, the document camera 21 is effectively used, and the read image of the document 2 may be saved onto the appropriate storage location.

In the present exemplary embodiment, the multifunction peripheral 10 is equipped with the document camera 21 as a reading unit for the document 2 instead of an existing scanner. However, the multifunction peripheral 10 may be equipped with an existing scanner, and both the document camera 21 and the scanner may be used as a reading unit for the document 2. As described above, although the document camera 21 according to the present exemplary embodiment is configured to perform two types of scanning, “pre-scanning” and “actual scanning”, the scanner may be configured to perform “actual scanning” if the multifunction peripheral 10 is equipped with the existing scanner.

Although the file system 40 in the cloud 4 is used as the storage location for the file corresponding to the read image of the document 2 in the present exemplary embodiment, this is not meant to be limiting, and the storage location may be a storage unit located, for example, inside the multifunction peripheral 10 or in the on-premises environment.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))
   An image processing system comprising:
   a camera; and
   a processor configured to:
      analyze a captured image of a document on a document glass, the captured image being captured with the camera, and extract storage-location information from the document; and
      save a read image of the document onto a storage location specified by the storage-location information, the read image being acquired through image capturing by the camera in response to a reading instruction from a user.
(((2)))
   The image processing system according to (((1))),
   wherein the processor is configured to:
      when saving the read image by transmitting the read image after connecting to the storage location, before transmitting the read image, display a screen transmitted from the storage location in response to connecting to the storage location.
(((3)))
   The image processing system according to (((2))),
   wherein the processor is configured to:
      if the screen is a setting screen for setting a reading attribute for the document, prompt the user to set the reading attribute for the document in the setting screen; and
      generate the read image of the document in accordance with the reading attribute that has been set for the document.
(((4)))
   The image processing system according to (((2))),
   wherein the screen provides information indicating a folder designated as the storage location.
(((5)))
   A program causing a computer to execute a process, the process comprising:
   analyzing a captured image of a document on a document glass, the captured image being captured with a camera, and extracting storage-location information from the document; and
   saving a read image of the document onto a storage location specified by the storage-location information, the read image being acquired through image capturing by the camera in response to a reading instruction from a user.

What is claimed is:

1. An image processing system comprising:
a camera; and
a processor configured to:
analyze a captured image of a document on a document glass, the captured image being captured with the camera, and extract storage-location information from the document; and
save a read image of the document onto a storage location specified by the storage-location information, the read image being acquired through image capturing by the camera in response to a reading instruction from a user.

2. The image processing system according to claim 1,
wherein the processor is configured to:
when saving the read image by transmitting the read image after connecting to the storage location, before transmitting the read image, display a screen transmitted from the storage location in response to connecting to the storage location.

3. The image processing system according to claim 2,
wherein the processor is configured to:
if the screen is a setting screen for setting a reading attribute for the document, prompt the user to set the reading attribute for the document in the setting screen; and
generate the read image of the document in accordance with the reading attribute that has been set for the document.

4. The image processing system according to claim 2,
wherein the screen provides information indicating a folder designated as the storage location.

5. A non-transitory computer readable medium storing a program causing a computer to execute a process, the process comprising:
analyzing a captured image of a document on a document glass, the captured image being captured with a camera, and extracting storage-location information from the document; and
saving a read image of the document onto a storage location specified by the storage-location information, the read image being acquired through image capturing by the camera in response to a reading instruction from a user.

6. An image processing method comprising:
analyzing a captured image of a document on a document glass, the captured image being captured with a camera, and extracting storage-location information from the document; and
saving a read image of the document onto a storage location specified by the storage-location information, the read image being acquired through image capturing by the camera in response to a reading instruction from a user.
